(19) United States
(12) Patent Application Publication
(10) Pub. No.: US 2009/0289032 A1
(43) Pub. Date: Nov. 26, 2009

(54) METHOD AND KIT FOR SURFACE PREPARATION

(75) Inventors: Kevin Warner Flanagan, Troy, NY (US); Wendy Wen-Ling Lin, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/126,059

(22) Filed: May 23, 2008

(51) Int. Cl. C09K 13/04; B44C 1/22

(52) U.S. Cl. 216/34; 252/79.2

(57) ABSTRACT

A method includes contacting a treatment composition including a permanganic acid to a surface of a first substrate to form a treated substrate surface, wherein the first substrate comprises a polyarylenesulfide. The method further includes adhesively bonding the treated substrate surface to a second substrate surface. An associated kit is also provided

### BACKGROUND

1. Technical Field

The invention includes embodiments that relate to surface preparation method for adhesive bonding. The invention includes embodiments that relate to a surface preparation kit for adhesive bonding.

2 . Discussion of Related Art

Poly(phenylene sulfide) (PPS) may be employed in aircraft and automobile applications because of its chemical resistance, high temperature stability, and fire safety. Attaining a strong adhesive bond to PPS may be difficult, due to in part to the semi-crystalline nature of the resin. Hence, assembly of poly(phenylene sulfide) parts may be affected by other techniques such as melt bonding (also known as welding or fusion bonding) or through the use of fasteners. A source of heat may be employed to melt the mating surfaces of the PPS joint, (such as, ultrasonic, induction, and resistive welding) or by using mechanical fasteners.

However, melt-bonding techniques may require specialized equipment to heat poly(phenylene sulfide) above the melt temperature under controlled conditions. This may increase the possibility of distorting the component, or in the case of repair situations, causing additional damage to the repair area. Further, melt-bonding techniques may require geometry specific tooling and equipment to produce a bond and may not be very effective where access to the bond area is limited. Mechanical fasteners may not be effective for joining continuous fiber reinforced PPS laminate structures, because the holes required for fastener attachment may damage the reinforcing fibers and compromise the mechanical integrity of the structure.

Several factors make field repair of composite aircraft structures a specialized case for assembly of composite joints. Reliability of repaired structures is critical to ensure safe operation of the aircraft. Therefore, detailed guidelines, methods, and requirements for repair of aircraft structures are documented in a variety of forms, and may originate from the aircraft manufacturers, regulatory organizations, or advisory organizations. Minimizing the time and cost required to make reliable field repairs is of great importance to aircraft operators and end-users, particularly for commercial airlines or military aircraft operators. In the commercial case, aircraft grounded for repair can lead to financial loss due to flight cancellation, customer dissatisfaction, and schedule disruption. In the military case, grounded aircraft represent a loss of strategic and tactical capability. Damage can take many different forms, such as abrasion, charring, cracking, delamination, impact, and scratching.

Another aspect regarding field repair of composite aircraft structures is the degree of variation in how, where, when, and to what degree damage may occur in a given aircraft component. For example, damage may occur in different forms through such varied causes as lightning strike, chemical exposure, hard-body impact, or fatigue. The size and shape of the damaged area may vary greatly, thereby dictating the size and shape of the repair that must be undertaken. The aircraft's location at the time of repair may dictate the resources available for repair, as well as the conditions under which repair must be accomplished. In some cases, access to the damaged area may be physically limited by surrounding structures. In some cases, the use of certain repair methods may be limited due to incompatibility with adjacent structures. The need to maintain aerodynamic surfaces, part-to-part clearances, or weight balances may also influence the nature of the repair. Bolted repairs of PPS composite parts, and of fiber reinforced composite laminates, may be problematic relative to adhesively bonded repairs.

It may be desirable to have methods and kits of bonding a poly(phenylene sulfide) surface that have characteristics different from those currently available.

### BRIEF DESCRIPTION

In one embodiment, a method is provided. The method includes contacting a treatment composition including a permanganic acid to a surface of a first substrate to form a treated substrate surface, wherein the first substrate comprises a polyarylenesulfide. The method further includes adhesively bonding the treated substrate surface to a second substrate surface.

In one embodiment, a kit is provided. The kit includes a treatment composition and the treatment composition includes permanganic acid. The kit further includes an instruction set for treating a surface of a substrate including a polyarylenesulfide with the treatment composition.

In one embodiment, a method is provided. The method includes contacting a surface of a damaged aircraft thermoplastic composite structure with a treatment composition that includes an oxidizing acid selected from the group consisting of permanganic acid, nitric acid, and both nitric acid and permanganic acid. The method includes applying an adhesive layer to at least a portion of the treated surface; and contacting a repair patch to the adhesive layer.

In one embodiment, a repair kit for a damaged aircraft thermoplastic composite structure is provided. The repair kit includes a treatment composition including an oxidizing agent selected from the group consisting of nitric acid and permanganic acid. The repair kit further includes an instruction set for treating a surface of the damaged aircraft thermoplastic composite structure with the treatment composition.

### BRIEF DESCRIPTION OF DRAWING FIGURES

FIG. 1 shows a cross-section of an adhesively bonded article in accordance with one embodiment of the invention.

FIG. 2 shows a cross-section of an adhesively bonded article in accordance with one embodiment of the invention.

FIG. 3 shows a cross-section of an adhesively bonded article in accordance with one embodiment of the invention.

FIG. 4 shows the SEM micrographs of permanganic-acid treated surface, nitric-acid treated surface, and control blank.

FIG. 5 shows the SIMS positive ion spectrum of permanganic-acid treated surface, nitric-acid treated surface, and control blank.

FIG. 6 shows the lap shear strength values for permanganic-acid treated surface, nitric-acid treated surface, and acetone-treated surface.

FIG. 7 shows the lap shear strength values for permanganic-acid treated surface using different treatment conditions.

FIG. 8 shows the stress at maximum load values for surface-treated surfaces using different treatment techniques.

### DETAILED DESCRIPTION

The invention includes embodiments that relate to surface preparation method for adhesive bonding. The invention includes embodiments that relate to a surface preparation kit for adhesive bonding.

In the following specification and the clauses which follow, reference will be made to a number of terms have the following meanings. The singular forms “a”, “an” and “the” include plural referents unless the context clearly dictates otherwise. Approximating language, as used herein throughout the specification and clauses, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity can not occur—this distinction is captured by the terms “may” and “may be”.

The invention includes a method for adhesive bonding in one embodiment. The method includes contacting a treatment composition including a permanganic acid to a surface of a first substrate to form a treated substrate surface, wherein the first substrate comprises a polyarylenesulfide. The method further includes adhesively bonding the treated substrate surface to a second substrate surface.

In one embodiment, a method for repair of a damaged aircraft thermoplastic composite structure is provided. The method includes contacting a surface of a damaged aircraft thermoplastic composite structure with a treatment composition. The treatment composition includes an oxidizing acid selected from the group consisting of permanganic acid, nitric acid, and both nitric acid and permanganic acid. The method includes applying an adhesive layer to at least a portion of the treated surface, and contacting a repair patch to the adhesive layer.

In one embodiment, a treatment composition is provided. The treatment composition includes a permanganic acid. As used herein, the term permanganic acid includes permanganic acid or a source of permanganic acid (for example, a permanganate). In one embodiment, a permanganic acid includes an acid, any salts thereof, or both. Thus a permanganic acid may include HMnO₄, MnO₄, or both. The permanganic acid species itself, HMnO₄, is a strong oxidizing acid that may exist in solution. Permanganic acid may be prepared from its salts. In one embodiment, a treatment composition may include potassium permanganate (KMnO₄) as the source of permanganate anion. In one embodiment, a treatment composition may further include a second acid. In one embodiment, a second acid may include phosphoric acid (H₃PO₄). In one embodiment, the treatment composition may be a gel. In one embodiment, a treatment composition may include a silica gel. In one embodiment, the treatment composition may be an aqueous solution.

In one embodiment, a treatment composition may be prepared by preparing an aqueous solution of permanganic acid in the desired concentration in distilled water. A phosphoric acid solution may be added to the permanganic acid solution in the desired concentration. To prepare the gel, silica gel may be added to the resulting solution. The amount of silica gel added may vary depending on the consistency required. In one embodiment, the amount added may prevent the treatment composition from flowing, dripping, or sagging when applied on an inclined or overhead surface.

In one embodiment, a treatment composition may include potassium permanganate in an amount in a range of from about 10 grams per liter to about 12.5 grams per liter, from about 12.5 grams per liter to about 15 grams per liter, from about 15 grams per liter to about 17.5 grams per liter, from about 17.5 grams per liter to about 20 grams per liter, from about 20 grams per liter to about 22.5 grams per liter, or from about 22.5 grams per liter to about 25 grams per liter. In one embodiment, a treatment composition may include potassium permanganate in an amount less than about 25 grams per liter.

In one embodiment, a treatment composition may include phosphoric acid in a amount in a range of from about 10% (wt/wt) to about 15% (wt/wt), from about 15% (wt/wt) to about 20% (wt/wt), from about 20% (wt/wt) to about 30% (wt/wt), from about 30% (wt/wt) to about 40% (wt/wt), from about 40% (wt/wt) to about 50% (wt/wt), from about 50% (wt/wt) to about 60% (wt/wt), from about 60% (wt/wt) to about 70% (wt/wt), or from about 70% (wt/wt) to about 80% (wt/wt).

In one embodiment, a treatment composition for a damaged aircraft thermoplastic structure is provided. The treatment composition includes nitric acid, permanganic acid, or both nitric acid and permanganic acid. As noted earlier for the permanganic acid, as used herein, the term nitric acid includes nitric acid or a source of nitric acid (for example, a nitrate). In one embodiment, a nitric acid includes an acid, any salts thereof, or both.

In one embodiment, a treatment composition may be prepared by preparing an aqueous solution of nitric acid in the desired concentration in distilled water. In one embodiment, the treatment composition includes nitric acid in an amount in a range of from about more than 15% wt. In another embodiment, an amount in a range of from about less than 70% wt. In another embodiment, the treatment composition includes nitric acid in an amount in a range of from about 15% wt to about 25% wt, from about 25% wt to about 35% wt, from about 35% wt/wt to about 45% wt, from about 45% wt to about 55% wt, or from about 55% wt to about 70% wt.

In one embodiment, the first substrate includes a polyarylenesulfide. A polyarylenesulfide as used herein refers to a polymer including at least one aromatic radical and at least one —S— linkage. An aromatic radical is an array of atoms having a valence of at least one and having at least one aromatic group. In one embodiment, an aromatic radical includes a phenylene radical and the first substrate includes polyphenylenesulfide.

In one embodiment, the first substrate includes a base substrate and a layer including poly(arylene sulfide). In one embodiment, a first substrate includes a laminate of a polyarylenesulfide and one or more additional layers. In one embodiment, the one or more additional layers may include a polymeric material. In one embodiment, the one or more additional layers may include a ceramic material. In one embodiment, the one or more additional layers may include a metal. In one embodiment, the one or more additional layers may include a fabric or a cloth. In one embodiment, the one or more additional layers may include fiberglass.

In one embodiment, a first substrate includes unfilled polyarylenesulfide. In one embodiment, a first substrate includes a polyarylenesulfide composite. In one embodiment, the polyarylenesulfide composite includes a polyarylenesulfide and one or more filler. In one embodiment, a filler may include one or more material selected from the group consisting of siliceous materials, carbonaceous materials, metal hydrates, metal oxides, metal borides, and metal nitrides.

In one embodiment, a filler may include a fibrous material. In one embodiment, a fibrous material may include a glass fiber or a ceramic fiber. Suitable examples of glass fibers may include E-glass or S-glass fiber. In one embodiment, a fibrous material may include a polymer fiber. Suitable examples of fibers may include, but are not limited to, glass fibers (for example, quartz, E-glass, S-2 glass, R-glass from suppliers such as PPG, AGY, St. Gobain, Owens-Corning, or Johns Manville), polyester fibers, polyamide fibers (for example, NYLON® polyamide available from E.I. DuPont, Wilmington, Del., USA), aromatic polyamide fibers (such as KEVLAR® aromatic polyamide available from E.I. DuPont, Wilmington, Del., USA; or P84® aromatic polyamide available from Lenzing Aktiengesellschaft, Austria), polyimide fibers (for example, KAPTON® polyimide available from E.I. DuPont, Wilmington, Del., USA), or extended chain polyethylene (for example, SPECTRA® polyethylene from Honeywell International Inc., Morristown, N.J., USA; or DYNEEMA® polyethylene from Toyobo Co., Ltd.).

In one embodiment, a fibrous material may include a carbon fiber. Suitable examples of carbon fibers may include, but are not limited to, AS2C, AS4, AS4C, AS4D, AS7, IM6, IM7, IM9, and PV42/850 from Hexcel Corporation; TORAYCA T300, T300J, T400H, T600S, T700S, T700G, T800H, T800S, T1000G, M35J, M40J, M46J, M50J, M55J, M60J, M30S, M30G, and M40 from Toray Industries, Inc; HTS12K/24K, G30-500 3K/6K/12K, G30-500 12K, G30-700 12K, G30-700 24K F402, G40-800 24K, STS 24K, HTR 40 F22 24K 1550tex from Toho Tenax, Inc; 34-700, 34-700WD, 34-600, 34-600WD, 34-600 Unsized from Grafil inc.; T-300, T-650/35, T-300C, or T-650/35C from Cytec Industries.

In one embodiment, a first substrate is a damaged aircraft thermoplastic composite structure. In one embodiment, the damaged aircraft thermoplastic structure includes a poly(phenylene sulfide) composite. In one embodiment, the poly(phenylene sulfide) composite includes a fibrous material as described herein.

In one embodiment, a surface of the first substrate may be pre-treated with a surface pre-treatment method before contacted the first substrate with the treatment composition. Suitable pre-treatment methods may include mechanical, heat, flame, corona, or plasma. In one embodiment, a first substrate may be pre-treated by wiping the surface of the first substrate with a solvent. A solvent may be used to remove contaminants such as dirt particles from the surface. Suitable solvents may include one or more of methyl ethyl ketone (MEK), trichloroethylene, toluene, or acetone. In one embodiment, a surface of the first substrate may be further roughened using an abrasive followed by removal of abrasive particles by using clean dry air or nitrogen, by using vacuum, or a dry wipe. The roughened surface may be further wiped with a solvent as described hereinabove.

In one embodiment, the technique employed to contact a surface of the first substrate with the treating composition may be determined by one or more of the desired bond strength of an adhesive bond involving the treated first substrate, the size and shape of the first substrate to be treated, the temperature desired for treatment, or the potential application of the treated first substrate. In one embodiment, the techniques of treatment may include one or more of spraying, wiping, brushing, pouring, sprinkling, immersion, or exposure to vapors. In one embodiment, a first substrate may be contacted with the treatment composition by wetting the surface of the first substrate with the treatment composition using a wipe or a brush.

In one embodiment, the temperature of the surface treatment may depend on one or more of the desired bond strength of an adhesive bond involving the treated first substrate, the melting point of the treating agent, the boiling point of the treating agents, ambient conditions, the concentration of the treating agent, the desired treatment time, the softening (T_{g}), the melting temperature, or the decomposition temperature of the poly(arylene sulfide) first substrate. In one embodiment, the temperature for the treatment may be in a range of from about 25 degrees Celsius to about 50 degrees Celsius, from about 50 degrees Celsius to about 100 degrees Celsius, from about 150 degrees Celsius to about 175 degrees Celsius, from about 175 degrees Celsius to about 200 degrees Celsius, from about 200 degrees Celsius to about 225 degrees Celsius, from about 225 degrees Celsius to about 250 degrees Celsius, or from about 250 degrees Celsius to about 275 degrees Celsius. In one embodiment, the temperature for the treatment may be in a range of about room temperature.

In one embodiment, the time of exposure of a surface of the first substrate to the treatment composition may depend on the concentration of the treating agents and the temperatures used. In one embodiment, the time of exposure may vary in a range of from about 10 seconds to about 15 seconds, from about 15 seconds to about 30 seconds, from about 30 seconds to about 1 minute, from about 1 minute to about 5 minutes, from about 5 minutes to about 10 minutes, from about 10 minutes to about 15 minutes, or from about 15 minutes to about 30 minutes. In one embodiment, the time of exposure may vary in a range of from about 1 hour to about 50 minutes, from about 50 minutes to about 40 minutes, or from about 40 minutes to about 31 minutes.

In one embodiment, after the treatment of the first substrate with the treatment composition as described hereinabove, any treating agent, which has remained on the surface of the first substrate, may be removed therefrom. This removal may be done by drying of the surface by evaporation after the surface has been rinsed, by rinsing, or by wiping the surface of the first substrate with a solvent. In one embodiment, the treated first substrate surface may be dried by vacuum or air dried after contacting a surface of the first substrate with the treatment composition.

In one embodiment, a treated substrate surface may have surface characteristics (for example, morphology or surface chemistry) different from that of a substrate surface that is not exposed to the treatment composition. In one embodiment, a treated substrate surface may have surface characteristics different from that of a substrate surface that is treated with a treatment composition different from that of permanganic acid-based treatment composition. In one embodiment, a treated substrate surface may show different surface characteristics for different treatment conditions (concentration, time, temperature). In one embodiment, a treated substrate surface may be characterized by its secondary mass ion spectrometry (SIMS) positive ion spectrum. In one embodiment, a treated substrate surface may be characterized by scanning electron microscopy.

In one embodiment, the method includes adhesive-bonding the treated first substrate to a second substrate. The method includes treating the first substrate with a treatment composition as described hereinabove followed by adhesive bonding of the treated substrate surface with the second substrate surface.

In one embodiment, the second substrate includes a metal or a metal alloy, for example, steel, aluminum, or copper. In one embodiment, a second substrate includes a ceramic material. In one embodiment, a second substrate includes wood, ceramic, or concrete. In one embodiment, the second substrate includes a polymeric material. In one embodiment, a suitable polymeric material may include one or more of poly(arylene sulfide), polyethylene, polypropylene, poly(vinyl chloride), poly acrylonitrile-butadiene-styrene, or polystyrene. In one embodiment, a second substrate includes poly(phenylene sulfide).

In one embodiment, a second substrate includes a prepreg. In one embodiment, a second substrate includes a composite. In one embodiment, a second substrate includes a polymer composite. In one embodiment, a second substrate includes a thermoplastic composite. In one embodiment, a second substrate includes a polyarylenesulfide composite. In one embodiment, the polyarylenesulfide composite includes a polyarylenesulfide and one or more filler. In one embodiment, a filler may include one or more material selected from the group consisting of siliceous materials, carbonaceous materials, metal hydrates, metal oxides, metal borides, and metal nitrides.

In one embodiment, a second substrate includes a laminate of two or more layers. In one embodiment, the two or more layers may include a polymeric material. In one embodiment, two or more layers may include a ceramic material. In one embodiment, the two or more layers may include a metal. In one embodiment, the two or more layers may include a fabric or a cloth. In one embodiment, the two or more layers may include fiberglass.

In one embodiment, the second substrate is a repair patch for the damaged aircraft composite structure. In one embodiment, a repair patch includes a composite metal patch, a pre-cured composite patch, a prepeg composite patch, or a wet-layup composite patch.

In one embodiment, a surface of the second substrate is pretreated before adhesive bonding to the treated first substrate surface. Pre-treatment of the surface of the second substrate may provide for improved adhesive strength between the first substrate and the second substrate. Suitable pre-treatment methods may include mechanical, heat, flame, corona, plasma, anodization, or conversion coating. In one embodiment, a surface of the second substrate may be pre-treated by wiping the surface of the second substrate with a solvent. A solvent may be used to remove contaminants such as dirt particles from the surface. Suitable solvents may include one or more of methyl ethyl ketone (MEK), trichloroethylene, toluene, or acetone. In one embodiment, a surface of the second substrate may be further roughened using an abrasive followed by removal of abrasive particles by using clean dry air or nitrogen, by using vacuum, or a dry wipe. The roughened surface may be further wiped with a solvent as described hereinabove.

In one embodiment, a surface of the second substrate may be also contacted with a treatment composition including permanganic acid or nitric acid, as described hereinabove. In one embodiment, the surface of the second substrate may be subjected to the same treatment conditions as the surface of the first substrate.

In one embodiment, the method further includes applying an adhesive composition to the treated first substrate surface after the contacting step and prior to the adhesively bonding step. In one embodiment, the adhesive composition may be applied to the treated first substrate surface as a liquid, a supported film, an unsupported film, paste, solution, an emulsion, or as a hot melt. The thickness of the adhesive film may be determined by the desired bond strength.

The type of adhesive employed may depend on one or more of the type of the second substrate surface employed, the intended use of the bonded article, the desirable bonding conditions, or the shape and size of the substrates to be bonded. In one embodiment, a suitable adhesive composition may include one or more of epoxy, cyanoacrylate, polysulfone, rubber, polyamide, acrylic, bismaleimide, or silicone. In one embodiment, an adhesive composition may essentially include epoxy. In one embodiment, a suitable adhesive composition may include FM 123-2 epoxy-based adhesive available from Cytec Industries (West Paterson, N.J.). In one embodiment, a suitable adhesive composition may include FM1515 epoxy-based adhesive available from Cytec Industries.

An adhesive composition may be applied to the treated first substrate surface, to the second substrate surface, or both the surfaces. In one embodiment, a method may include contacting a surface of the second substrate also with an adhesive composition. In one embodiment, a method may include bonding a surface of the second substrate with the treated first substrate surface using an adhesive composition sandwiched between the two surfaces. In one embodiment, the method includes solidifying the adhesive composition between the treated first substrate surface and the second substrate surface. In one embodiment, the method includes curing the adhesive composition and bonding the treated first substrate surface with the second substrate surface.

The curing conditions such as contact time, temperature and pressure may depend on the adhesive used. In one embodiment, the curing conditions may be selected such that the adhesive cures, hardens, or polymerizes to a degree resulting in the bonding strength desired.

In one embodiment, the bonding temperature may be selected such that it is below the melting temperature, decomposition temperature, or deformation temperature of poly(arylene sulfide) and the second substrate. In one embodiment, the bonding temperature may be in arrange of from about 25 degrees Celsius to about 50 degrees Celsius, from about 50 degrees Celsius to about 75 degrees Celsius, from about 75 degrees Celsius to about 150 degrees Celsius, from about 150 degrees Celsius to about 200 degrees Celsius, from about 200 degrees Celsius to about 250 degrees Celsius, from about 250 degrees Celsius to about 300 degrees Celsius, or from about 300 degrees Celsius to about 375 degrees Celsius. In one embodiment, the bonding temperature may be in a range of about 175 degrees Celsius.

In one embodiment, bonding between the two substrates may be affected at pressures in a range of from about 10 psig to about 10,000 psig. In one embodiment, bonding between the two substrates may be affected at atmospheric pressure.

The time required for adhesively bonding the treated first substrate surface and the second substrate surface may depend on the type of adhesive used and the temperature employed. In one embodiment, the time of bonding may vary in a range of from about 1 minute to about 5 minutes, from about 5 minutes to about 15 minutes, from about 15 minutes to about 30 minutes, or from about 30 minutes to about 1 hour. In one embodiment, the time of bonding may vary in a range of from about 1 hour to about 2 hours, from about 2 hours to about 4 hours, from about 4 hours to about 8 hours, from about 8 hours to about 16 hours, or from about 16 hours to about 24 hours.

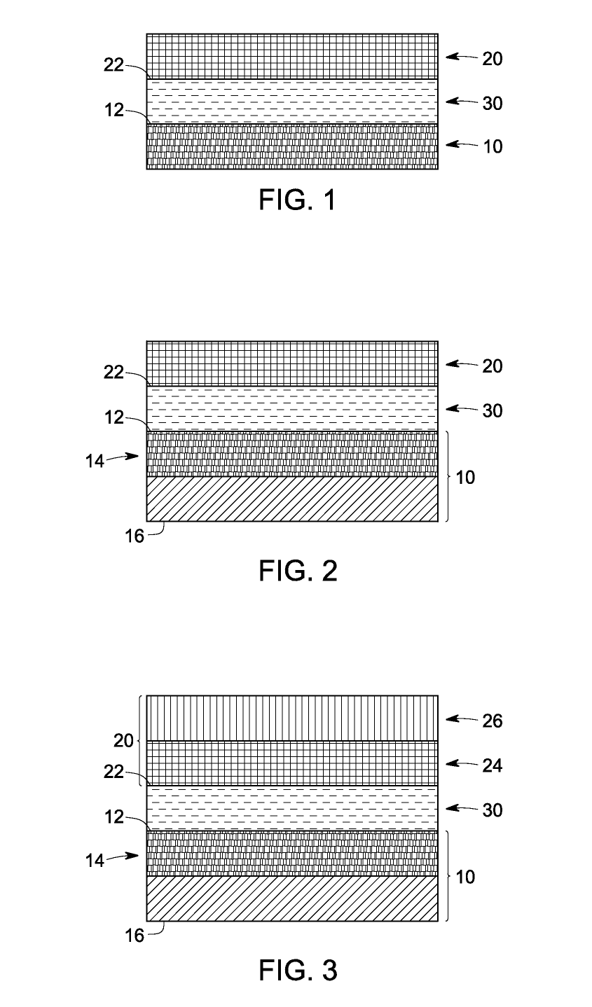

In one embodiment, an adhesively-bonded article is provided. The adhesively-bonded article is formed by the method as described hereinabove. In one embodiment, the adhesively-bonded article is a laminate as shown in FIG. 1. The laminate includes a first substrate 10 having a treated surface 12, a second substrate 20, and an adhesive layer 30 in contact with the treated first substrate surface 12 and the second substrate surface 22. The first substrate 10 includes poly(arylene sulfide). As noted earlier, the second substrate may be further treated with the treatment composition as described herein for the first substrate.

In one embodiment, the first substrate and the second substrate each include one layer as shown in FIG. 1. In another embodiment, a first substrate 10 includes two layers (14 and 16) as shown in FIG. 2. In one embodiment, a second substrate further includes two layers (24 and 26) as shown in FIG. 3. In one embodiment, the first substrate, the second substrate, or both the first substrate and the second substrate include two or more layers. In one embodiment, the adhesively bonded article is a repaired aircraft structure.

In one embodiment, the adhesively bonded article is characterized by physical properties (for example, lap shear strength) that are different for an adhesively bonded article that includes a substrate not treated with the treatment composition. In one embodiment, the repaired aircraft structure is characterized by physical properties (for example, lap shear strength) that are different for an adhesively bonded article that includes a substrate not treated with the treatment composition.

In one embodiment, the adhesively bonded article is characterized by physical properties (for example, lap shear strength) that are different for an adhesively bonded article that includes a substrate treated with treatment conditions (concentration, temperature, or time) different from that of permanganic acid-based treatment conditions. In one embodiment, the adhesively bonded article is characterized by physical properties (for example, lap shear strength) that are different for an adhesively bonded article that includes a substrate treated with treatment compositions different from that of permanganic acid-based treatment compositions.

In one embodiment, the adhesively-bonded article has a lap shear strength measured using ASTM D3164 method that is greater than about 2000 pounds per square inch. In one embodiment, the adhesively-bonded article has a lap shear strength measured using ASTM method that is greater than about 2500 pounds per square inch. In one embodiment, the adhesively-bonded article has a lap shear strength measured using ASTM method that is greater than about 3000 pounds per square inch. In one embodiment, the adhesively-bonded article has a lap shear strength measured using ASTM method that is greater than about 3500 pounds per square inch.

In one embodiment, a kit for treatment of a substrate is provided. The kit includes a treatment composition and the treatment composition includes permanganic acid. In one embodiment, the treatment composition further includes a phosphoric acid. In one embodiment, the treatment composition further includes a silica gel. In one embodiment, the treatment composition is a gel. In one embodiment, the treatment composition is an aqueous solution. The concentration of the different reagents in the treatment composition is as described hereinabove. In one embodiment, a kit includes an instruction set for treating a substrate including a polyarylenesulfide with the treatment composition.

In one embodiment, a repair kit for a damaged aircraft thermoplastic composite structure is provided. The repair kit includes a treatment composition having an oxidizing agent selected from the group consisting of nitric acid and permanganic acid. The repair kit includes an instruction set for treating a surface of the damaged aircraft thermoplastic composite structure with the treatment composition. In one embodiment, the repair kit includes an adhesive composition as described herein. In one embodiment, the repair kit includes a repair patch.

### EXAMPLES

The following examples are intended only to illustrate methods and embodiments in accordance with the invention, and as such should not be construed as imposing limitations upon the claims. Unless specified otherwise, all ingredients may be commercially available from such common chemical suppliers as Alpha Aesar, Inc. (Ward Hill, Mass.), Sigma Aldrich, Spectrum Chemical Mfg. Corp. (Gardena, Calif.), and the like.

### Example 1

### Surface Treatment with Permanganic Acid, Nitric Acid, and Acetone

Polyphenylene sulfide composite is obtained from Ten Cate Advanced Composites as a—product name CETEX, reinforced with T300 3K 5HS carbon fiber. Epoxy-based adhesives FM 1515 (cure temperature of about 175 degrees celcius) and FM 123-2 (cure temperature of about 120 degrees celcius) are obtained from Cytec Industries.

The permanganic acid-based treatment composition is prepared by combining two previously prepared and kitted aqueous solutions of phosphoric acid and potassium permanganate, respectively, such that the resulting solution contains 12% wt phosphoric acid 12.5 g/L potassium permanganate. A clean cotton cloth is moistened with the resulting solution, and the resulting solution is applied to the polyphenylene sulfide surface by wiping. The surface remains wetted with the solution for 1 minute. The surface is then wiped dry with a clean cotton cloth moistened with clean deionized water, to remove the residual solution. The surface is then wiped dry with a clean, dry cotton cloth to provide a first set of treated polyphenylene sulfide surfaces.

In sample 1, an adhesive FM1515 is applied to one of the first set of treated polyphenylene sulfide surfaces. In sample 2, an adhesive FM123-2 is applied to one of the first set of treated polyphenylene sulfide surfaces. Samples 1 and 2 are cured under a vacuum bag according to the adhesives manufacturers' recommended times and temperatures.

Polyphenylene sulfide surfaces are treated with 70% wt nitric acid. A clean cotton cloth is moistened with the nitric acid, and it is applied to the polyphenylene sulfide surface by wiping, so that the surface remains wetted for 30 seconds. The surface is then wiped with a clean cotton cloth moistened with clean deionized water, in order to remove the residual acid. The surface is then wiped dry with a clean, dry cotton cloth to provide a second set of treated polyphenylene sulfide surfaces. In sample 3, an adhesive FM1515 is applied to one of the second set of treated polyphenylene sulfide surfaces. In sample 4, an adhesive FM123-2 is applied to one of the second set of treated polyphenylene sulfide surfaces. Samples 3 and 4 are cured under a vacuum bag according to the adhesives manufacturers' recommended times and temperatures

Polyphenylene sulfide surfaces that are washed with acetone (no acid) in the same manner as given above to provide a third set of treated polyphenylene sulfide surfaces are used as control samples. In control sample 1, an adhesive FM1515 is applied to one of the third set of treated polyphenylene sulfide surfaces. In control sample 2, an adhesive FM123-2 is applied to one of the third set of treated polyphenylene sulfide surfaces. Control samples 1 and 2 are cured under a vacuum bag according to the adhesives manufacturers' recommended times and temperatures.

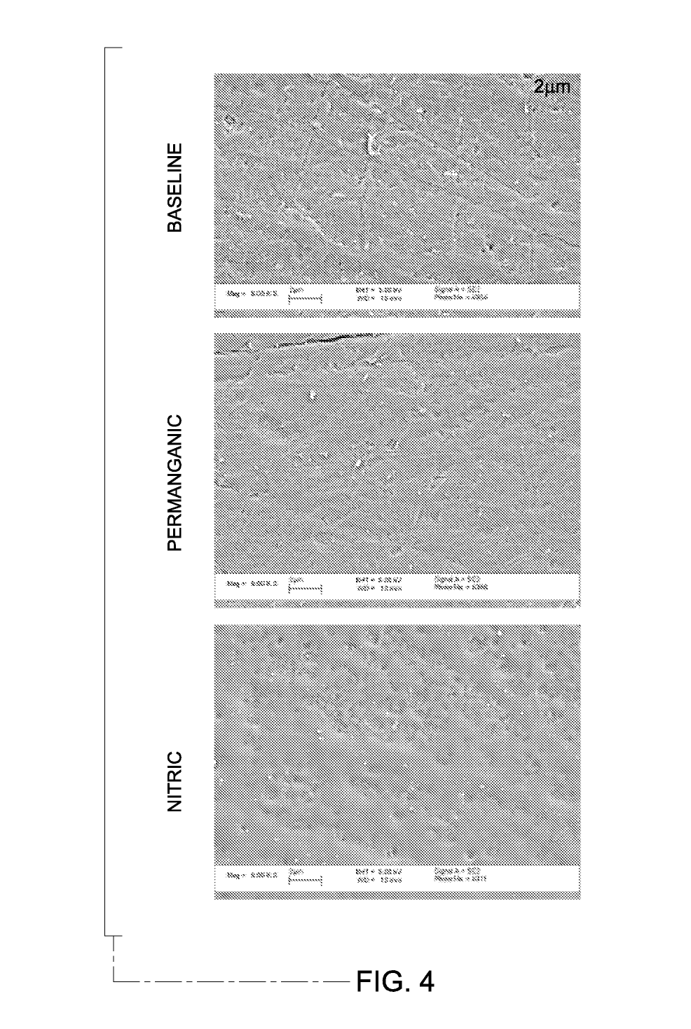

FIG. 4 shows the SEM micrographs of the first set, second set and third set of treated surfaces. The permanganic acid treated (first set of treated polyphenylene sulfide surfaces) and the nitric acid treated (second set of treated polyphenylene sulfide surfaces) surfaces show changes in surface morphology when compared to the third set of treated polyphenylene sulfide surfaces.

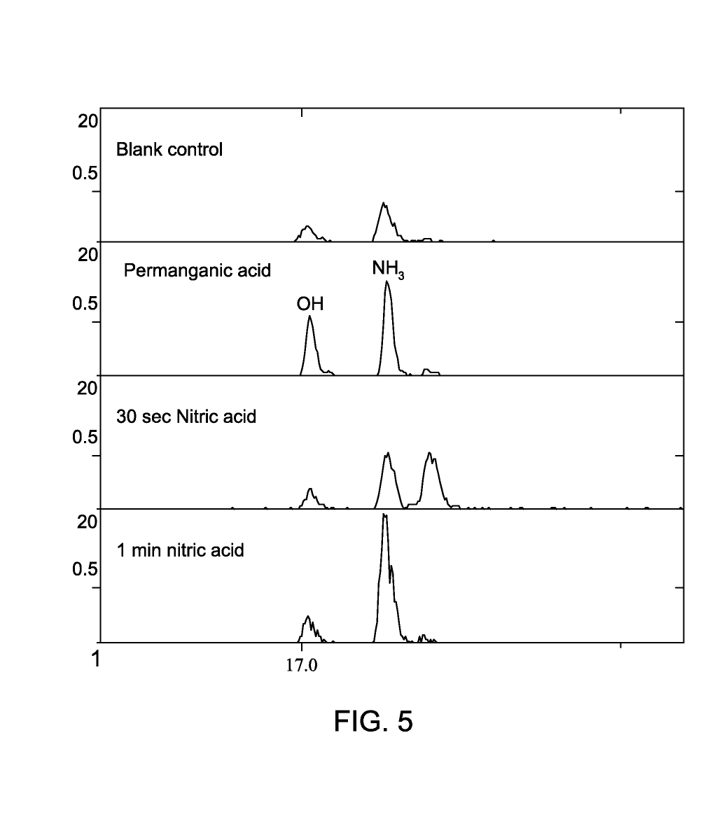

FIG. 5 shows the SIMS positive ion spectra for the permanganic acid-treated first set of polyphenylene sulfide surfaces and the third set of treated polyphenylene sulfide surfaces. As seen in the micrographs the permanganic acid-treated surfaces show enhanced OH peaks when compared to the third set of treated surfaces showing oxidation of the surface. For the nitric-acid treated second set of polyphenylene sulfide surfaces peaks due to C—N and O are observed. Peaks for hydroxyl group is not observed.

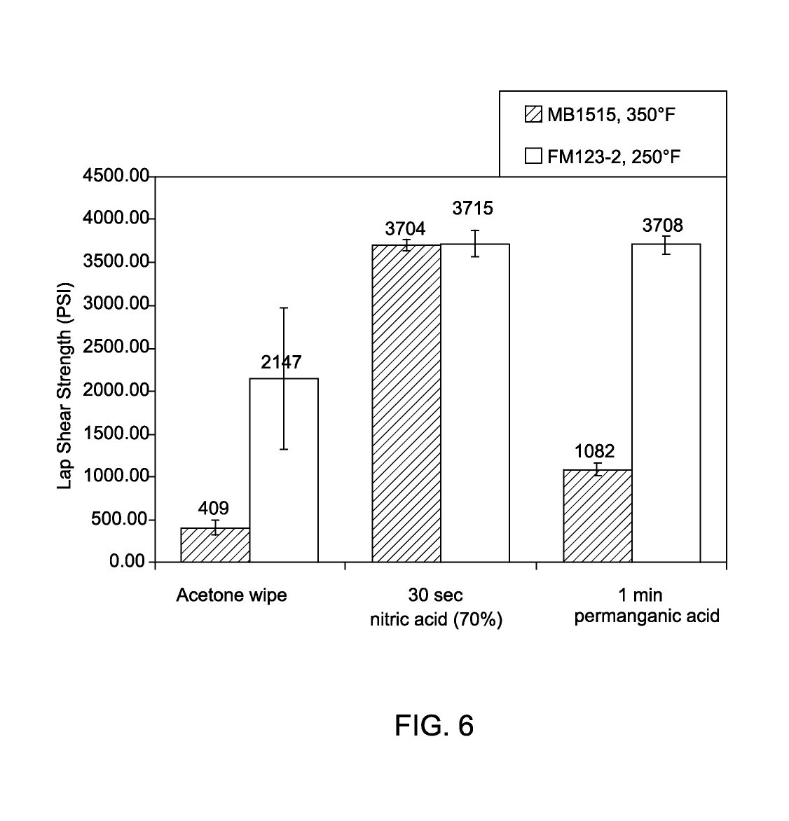

FIG. 6 shows the lap shear strength measured for the permanganic acid-treated surfaces and the control samples (third set of treated polyphenylene sulfide surfaces) bonded to the two epoxy-based adhesives. The permanganic-acid treated surface with the FM123-2 adhesive (sample 2) shows higher lap shear strength when compared to the permanganic-acid treated surface with the FM1515 adhesive (sample 1). Both the permanganic-acid treated surfaces show higher shear strength when compared to the third set of treated polyphenylene sulfide surfaces with the acetone wipe.

### Example 2

### Surface Treatment with Permanganic Acid Using Different Treatment Conditions

Two different concentrations of permanganic acid-based treatment compositions are prepared: using the method described in Example 1. The two different concentrations used are (1) ˜80% phosphoric acid and ˜20 g/L potassium permanganate and (2) 12% phosphoric acid and 12.5 g/L potassium permanganate.

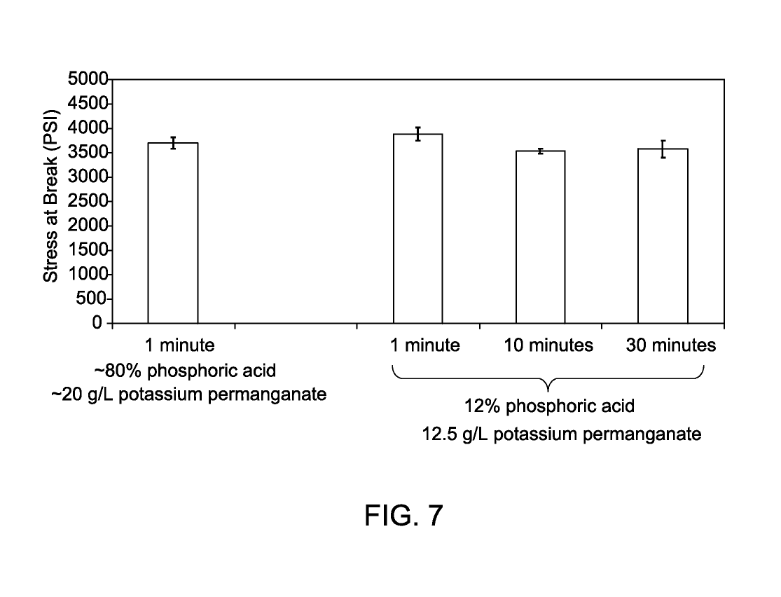

The two different treatment compositions are applied to the polyphenylenesulfide surface using the method described in Example 1 using different exposure times. FM123-2 adhesive is applied to the treated surfaces and cured at 250 F for 90 minutes in a vacuum bag. FIG. 7 shows the stress at break measured for the permanganic acid-treated surfaces. Polyphenylenesulfide surfaces treated with lower concentrations (12.5 g/L) of permanganic acid show stress at break values similar to that of surfaces treated with higher concentrations (20 g/L) of permanganic acid. In comparison, nitric acid is not as effective at the lower concentrations as used for permanganic acid-based treatment, unless longer treatment times or higher temperatures are used. Thus, higher concentrations, longer treatment times or higher temperatures are needed for equivalent results.

### Example 3

### Surface Treatment Using Different Surface Treatment Techniques

Acetone wipe, abrasion with aluminum oxide grit sandpaper, corona treatment techniques with a handheld corona treater, are used to prepare control surfaces.

An aqueous solution of nitric acid (70%) and a thioxotropic gel of permanganic acid (concentration, prepared using the method of Example 1) are used as oxidizing acids to prepare a PPS surface. Exposure time to the nitric acid is varied from 30 seconds and 1 minute and 1 minute, 5 minutes, 15 minutes, and 30 minutes for permanganic acid treatment.

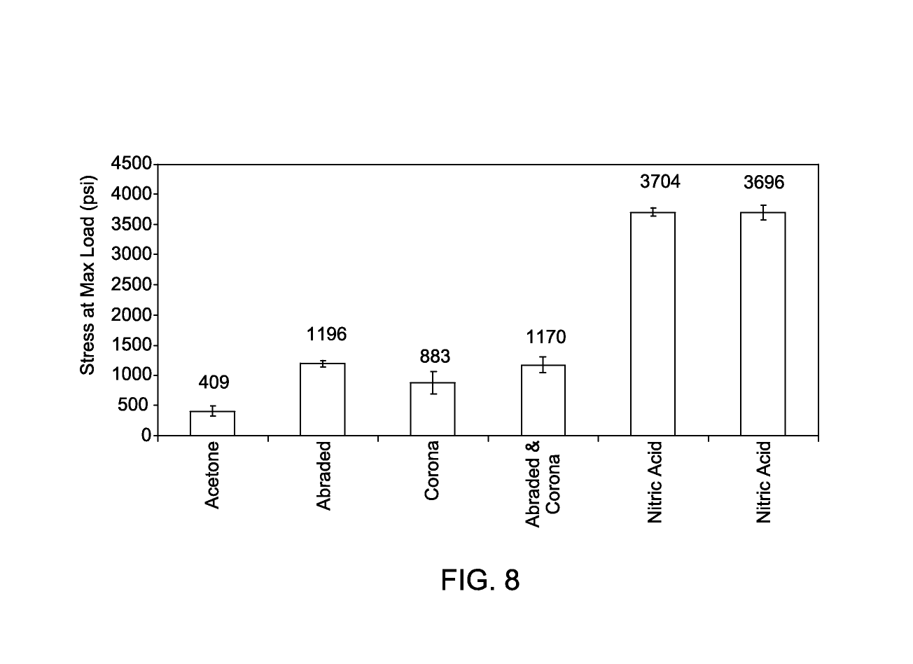

FM 1515 adhesive is applied to the treated surfaces and cured at 350 F for 90 minutes in a vacuum bag. FIG. 8 shows the stress at break measured for the different sets of treated polyphenylene sulfide surfaces. With the FM 1515 adhesives nitric-acid treated surfaces showed higher stress at break values.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The foregoing examples are illustrative of some features of the invention. The appended claims are intended to claim the invention as broadly as has been conceived and the examples herein presented are illustrative of selected embodiments from a manifold of all possible embodiments. Accordingly, it is Applicants' intention that the appended claims not limit to the illustrated features of the invention by the choice of examples utilized. As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations. Advances in science and technology may make equivalents and substitutions possible that are not now contemplated by reason of the imprecision of language; these variations should be covered by the appended claims.

1. A method, comprising:
contacting a treatment composition comprising a permanganic acid to a surface of a first substrate to form a treated substrate surface, wherein the first substrate comprises a polyarylenesulfide; and
adhesively bonding the treated substrate surface to a second substrate surface.

2. The method as defined in claim 1, wherein the treatment composition further comprises phosphoric acid.

3. The method as defined in claim 2, wherein the treatment composition comprises potassium permanganate.

4. The method as defined in claim 1, wherein the treatment composition comprises permanganic acid in an amount in a range of from about 10 grams per liter to about 25 grams per liter.

5. The method as defined in claim 1, wherein the treatment composition is a gel.

6. The method as defined in claim 1, wherein the treatment composition is contacted with the first substrate surface for a time period in a range of from about 30 seconds to about 30 minutes.

7. The method as defined in claim 1, wherein the polyarylenesulfide comprises a polyphenylenesulfide.

8. The method as defined in claim 1, wherein the second substrate comprises a polyphenylenesulfide.

9. The method as defined in claim 1, wherein the second substrate comprises a metal or metal alloy.

10. The method as defined in claim 1, wherein the second substrate comprises a ceramic material.

11. The method as defined in claim 1, further comprising applying an adhesive composition to the treated first substrate surface after the contacting step and prior to the adhesively bonding step.

12. The method as defined in claim 11, wherein the adhesive composition comprises an epoxy.

13. The method as defined in claim 11, comprising curing the adhesive composition and bonding the first substrate with the second substrate.

14. An adhesively-bonded article formed by the method of claim 1.

15. The adhesively-bonded article as defined in claim 14, wherein the adhesively bonded article has a lap shear strength measured using ASTM method D3164 that is greater than about 2000 pounds per square inch.

16. The adhesively-bonded article as defined in claim 14, wherein the adhesively bonded article has a lap shear strength measured using ASTM method D3164 that is greater than about 3500 pounds per square inch.

17. A surface treatment kit, comprising:
a treatment composition comprising permanganic acid; and
an instruction set for treating a surface of a substrate comprising a polyarylenesulfide with the treatment composition.

18. The surface treatment kit as defined in claim 17, wherein the treatment composition further comprises a phosphoric acid.

19. The surface treatment kit as defined in claim 17, wherein the treatment composition is a gel.

20. A method, comprising:
contacting a surface of a damaged aircraft thermoplastic composite structure with a treatment composition that comprises an oxidizing acid selected from the group consisting of permanganic acid, nitric acid, and both nitric acid and permanganic acid;
applying an adhesive layer to at least a portion of the treated surface; and
contacting a repair patch to the adhesive layer.

21. The method as defined in claim 20, wherein the treatment composition comprises nitric acid in an amount in a range of from about 15% wt to about 70% wt.

22. The method as defined in claim 3, wherein the treatment composition comprises permanganic acid in an amount in a range of from about 10 grams per liter to about 25 grams per liter.

23. The method as defined in claim 1, wherein the repair patch comprises a composite metal patch, a pre-cured composite patch, a prepeg composite patch, or a wet-layup composite patch.

24. A repaired aircraft structure formed by the method of claim 1.

25. A repaired aircraft structure as defined in claim 24, wherein the repaired aircraft structure has a lap shear strength measured using ASTM method D3164 that is greater than about 2000 pounds per square inch.

26. A repair kit for a damaged aircraft thermoplastic composite structure, comprising:
a treatment composition comprising an oxidizing agent selected from the group consisting of nitric acid and permanganic acid; and
an instruction set for treating a surface of the damaged aircraft thermoplastic composite structure with the treatment composition.

27. The repair kit as defined in claim 26, comprising an adhesive composition.

28. The repair kit as defined in claim 26, comprising a repair patch.
